(19) United States
(12) Patent Application Publication
(10) Pub. No.: US 2019/0061576 A1
(43) Pub. Date: Feb. 28, 2019

(54) POWER SOURCE FOR THERMAL COMPONENTS

(71) Applicant: Faurecia Automotive Seating, LLC, Auburn Hills, MI (US)

(72) Inventor: Shaun D. TAIT, Troy, MI (US)

(21) Appl. No.: 16/058,235

(22) Filed: Aug. 8, 2018

Related U.S. Application Data
(60) Provisional application No. 62/551,281, filed on Aug. 29, 2017.

(51) Int. Cl. B60N 2/56; B60R 16/033; H02J 7/00; H05B 1/02

(52) U.S. Cl. CPC B60N 2/5678; B60R 16/033; B60N 2/5628; H05B 1/0238; B60N 2/5685; H02J 7/0063

(57) ABSTRACT

An occupant support includes a vehicle seat including a cushion and trim arranged to extend around the cushion. An occupant-comfort system includes a heat-transfer station located in spaced-part relation from the trim and configured to move heat to the occupant in a heating mode and from the occupant in a cooling mode.

### PRIORITY CLAIM

This application claims priority under 35 U.S.C. § 119(e) to U.S. Provisional Application Ser. No. 62/551,281, filed Aug. 29, 2017, which is expressly incorporated by reference herein.

### BACKGROUND

The present disclosure relates to an occupant support, and particularly to a vehicle seat. More particularly, the present disclosure relates to a power source for thermal components of a vehicle seat.

### SUMMARY

According to the present disclosure, an occupant support includes a vehicle seat including a cushion and trim. The trim is arranged to extend around the cushion.

In illustrative embodiments, the occupant support further includes an occupant-comfort system. The occupant-comfort system includes a heat-transfer station located in spaced-part relation from the trim and configured to move heat to the occupant in a heating mode and from the occupant in a cooling mode. A heat conductor is coupled to the heat-transfer station and located between the cushion and the trim. The heat conductor is configured to communicate heat between the heat-transfer station and the occupant. A power supply is coupled to the vehicle and configured to supply a voltage level to power a thermal device included in the heat-transfer station.

In illustrative embodiments, the power supply includes a battery and a voltage adjustment system interconnecting the battery and the thermal device. The voltage adjustment system is configured to adjust the voltage level sent to the thermal device to minimize the amount of time required for the thermal device to reach a peak operating temperature.

In illustrative embodiments, the voltage adjustment system may have an adjustment cap including a timer programmed with a predetermined time limit corresponding to the peak operating temperature of the thermal device and configured to stop adjustment of the voltage sent to the thermal device once the predetermined time limit is reached.

In illustrative embodiments, the vehicle seat may have a seat back coupled to a seat bottom. The heat-transfer station may be positioned in the seat back. The heat-transfer station may be positioned in the seat bottom. A first heat-transfer station may be positioned in the seat back and a second heat transfer station may be positioned in the seat bottom.

In illustrative embodiments, a controller may be provided to select a heating or a cooling mode.

In illustrative embodiments, the thermal device may include at least one of resistive wires, heat pipes, heat pumps, or an air conditioner.

In illustrative embodiments, the battery may be a vehicle battery.

In illustrative embodiments, the voltage adjustment system may supply a voltage of approximately 16 volts to the thermal device for a predetermined time limit. The battery may supply a voltage of approximately 12 volts after the predetermined time limit is reached.

In illustrative embodiments, a method of conditioning a vehicle seat includes setting a predetermined temperature on a control panel. The method also includes adjusting the voltage level sent to a thermal device to minimize an amount of time required for the thermal device to reach a peak operating temperature. The method also includes stopping adjustment of the voltage sent to the thermal device once a predetermined time limit is reached.

In the illustrative embodiments, the method also includes supplying a voltage to the thermal device from the battery after the predetermined time limit is reached.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective and diagrammatic view, in accordance with the present disclosure, showing a vehicle seat with portions removed to show that the vehicle seat includes an occupant-comfort system configured to receive user inputs from an occupant to provide the occupant with a cooling sensation in a cooling mode and a heating sensation in a heating mode;

FIG. 2 is a diagrammatic view showing that the occupant-comfort system includes a power supply having a battery and a voltage adjustment system configured to adjust a voltage level provided by the battery and send the adjusted voltage level to at least one thermal device to provide the heating sensation in the heating mode or the cooling sensation in the cooling mode; and

FIG. 3 is a flowchart of a method for providing the heating sensation to the occupant using the occupant-comfort system.

### DETAILED DESCRIPTION

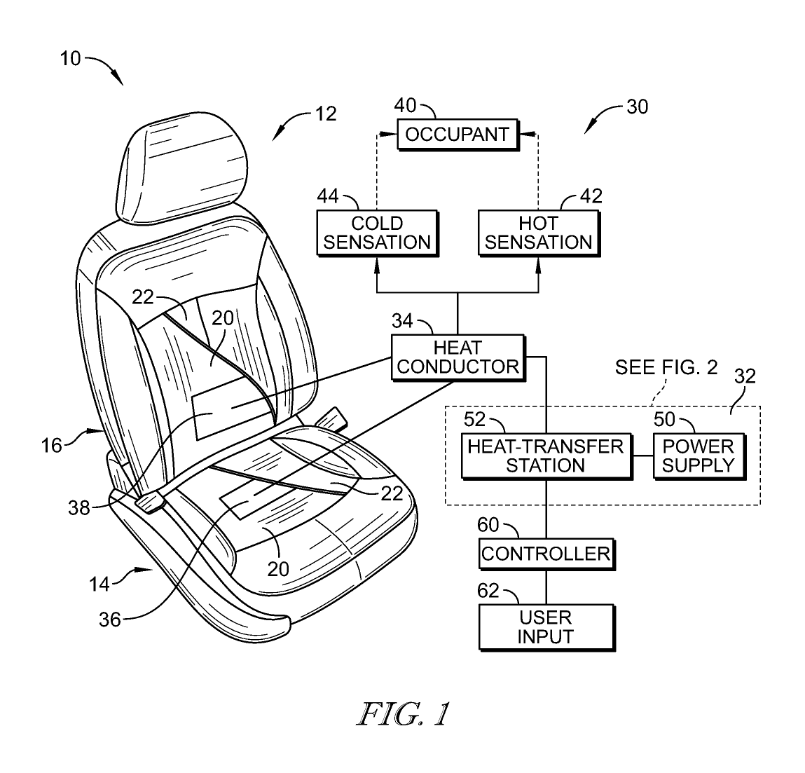

An occupant support 10 includes a vehicle seat 12 having a seat bottom 14 arrange to overlie the vehicle floor and a seat back 16 coupled to the seat bottom 14 and arranged to extend upward from the seat bottom 14 as shown in FIG. 1. The seat back 16 is configured to move relative to the seat bottom 14 between an upright position and a reclined position. The vehicle seat 12 includes a cushion 20 and a trim 22 surrounding and encasing the cushion 20. The vehicle seat 12 is illustrated with the trim 22 cut away to show the cushion 20 in FIG. 1.

An occupant-comfort system 30 is provided in the vehicle seat 12. The occupant-comfort system 30 includes a power assembly 32 and a heat conductor 34 coupled to the power assembly 32. In the illustrative embodiment, the heat conductor 34 includes a seat bottom conductor 36 positioned in the vehicle seat 12 and a seat back conductor 38 positioned in the seat back 16. In some embodiments, the vehicle seat 12 may only include the seat bottom conductor 36. In other embodiments, the vehicle seat 12 may only include the seat back conductor 38. The heat conductor 34 is positioned between the trim 22 and the cushion 20. The heat conductor 34 is configured to provide a thermal sensation to an occupant 40. The heat conductor 34 is configured to transfer heat to the occupant 40 with a heat sensation 42 when a heating mode is selected. The heat conductor 34 is configured to remove heat from the occupant 40 with a cold sensation 44 when a cooling mode is selected.

The power assembly 32 includes a power supply 50 coupled to a heat-transfer station 52. The power supply 32 provides a voltage to the heat-transfer station 52 to power the heat-transfer station 52. The heat-transfer station 52 provides heat to the heat conductor 34 when the heating mode is selected. The heat-transfer station 52 provides cooling to the heat conductor 34 when the cooling mode is selected.

A controller 60 includes a user input 62. The controller 60 is positioned within the vehicle so that the user input 62 is accessible to the occupant 40. For example, the user input 62 may be provided in a dashboard or console of the vehicle. The user input 62 includes buttons for the occupant 40 to select a heating or cooling mode. In some embodiments, the user input 62 may include a plurality of buttons to select varying degrees of heating or cooling. For example, each button may control a different temperature to be supplied by the heat-transfer station 52. The controller 60 receives input from the user input 62 and sends a signal to the heat-transfer 52 to control an output of the heat-transfer station 52.

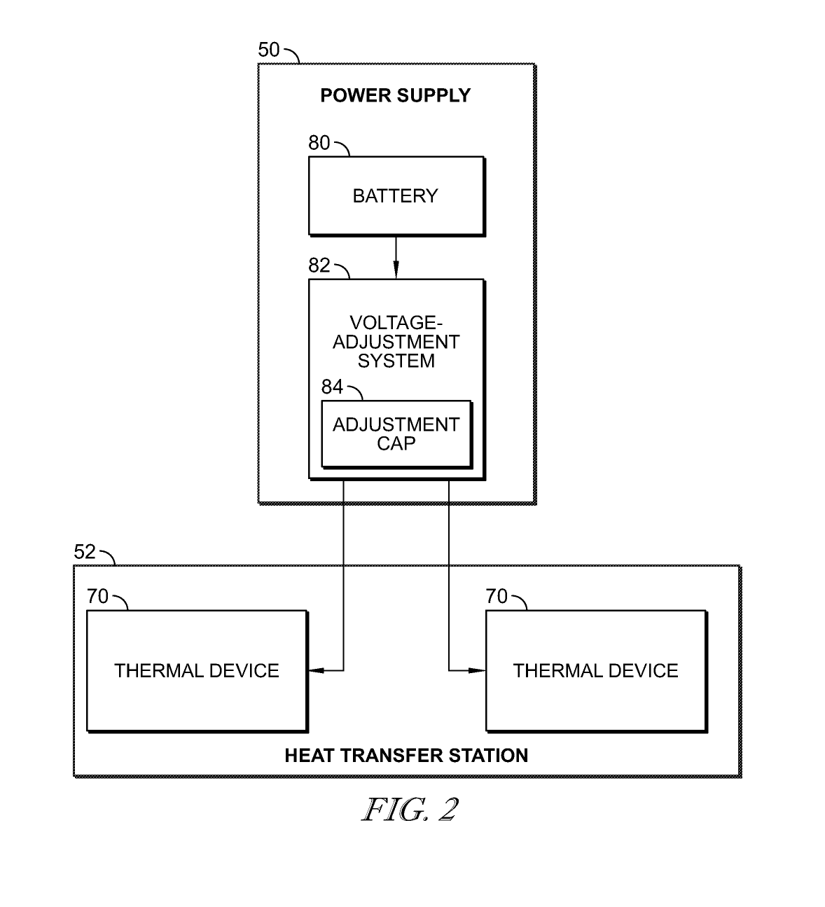

The heat-transfer station 52 includes at least one thermal device 70 as shown in FIG. 2. In the illustrative embodiment, the heat-transfer station 52 includes two thermal devices 70, wherein each thermal device 70 is coupled to one of the heat conductors 34. In some embodiments, a single thermal device 70 may be utilized to supply the heating or cooling sensation to both heat conductors 34. Additionally, in an embodiment having only one heat conductor 34, the heat-transfer station 52 may include only one thermal device 70. Illustratively, the thermal device 70 is a thermal-electric device configured to provide the heat sensation 42 in the heating mode or the cold sensation 44 in the cooling mode. In some embodiments, the thermal device 70 may be any suitable device configured to provide either a heating sensation or a cooling sensation, such as, for example, resistive wires, heat pipes, heat pumps, air conditioners, combinations of the same, or other suitable thermal devices.

The power supply 50 includes a battery 80 and a voltage-adjustment system 82 coupled electrically to the battery 80. The power supply 50 is configured to adjust voltage levels entering the heat-transfer station 52 to maximize performance of the thermal device 70. The battery 80 may be the vehicle battery, for example, a vehicle battery configured to power the vehicle's electronic components and the vehicle's electrical starter. In some embodiments, the battery 80 is a battery separate from the vehicle battery. The battery 80 supplies a voltage to the heat-transfer station 52, e.g. 12 volts.

The voltage-adjustment system 82 is configured to increase the voltage supplied to the heat-transfer station 52 when the heating or cooling mode is initiated. For example, the voltage-adjustment system 82 may supply a voltage of 16 volts to the heat-transfer station 52. In some embodiments, a combination of devices may be used to increase voltage levels, for example, when multiple thermal devices 70 are incorporated into the vehicle seat 12. The voltage-adjustment system 82 includes an adjustment cap 84 that controls a time period that the voltage-adjustment system 82 alters the voltage of the power supply 50. For example, upon selecting a heating or cooling mode, the voltage-adjustment system 82 raises the voltage sent from the power supply 50 to the heat-transfer station 52 to more quickly alter the temperature of the heat conductor 34. After a predetermined time, the adjustment cap 84 stops the alteration in voltage and the battery 80 continues to supply to voltage to the heat-transfer station 52.

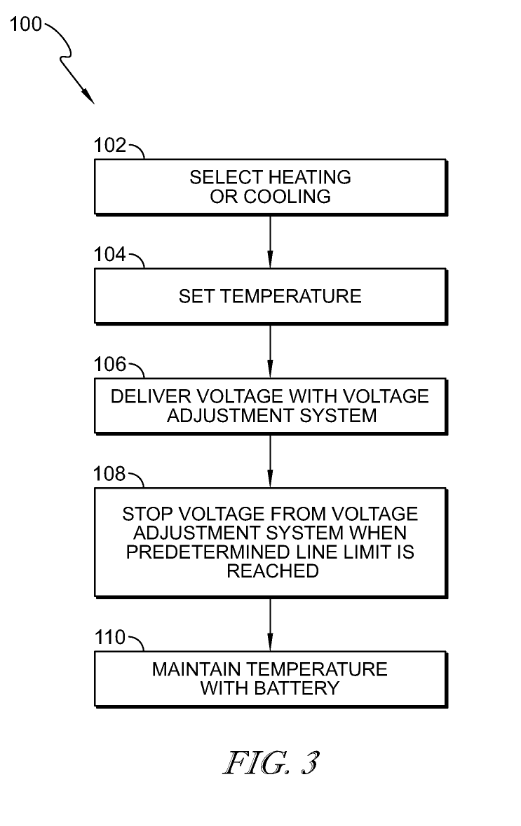

Referring to FIG. 3, a method 100 is provided for providing conditioning to the vehicle seat 12. The method 100 enables the occupant 40 to select the heat sensation 42 or the cold sensation 44. At block 102, the occupant 40 uses the user input 62 to select the heat sensation 42 or the cold sensation 44. Optionally, at block 104 that occupant 40 may set a desired temperature. For example, the user input 62 may have a temperature control to set a specific temperature, e.g. 68 degrees Fahrenheit. Alternatively, the user input 62 may allow the occupant 40 to select one of a plurality of predetermined temperatures, e.g. heating one, heating two, heating three. The battery 80 supplies an initial voltage to charge the thermal device 70.

At block 106, the voltage-adjustment system 82 increases the voltage from the battery 80 to increase the voltage to the thermal device 70 for a predetermined time. For example, a battery voltage of 12 volts may be increased to 16 volts. The voltage is delivered to the heat-transfer station 52 so that the thermal device 70 produces the desired heat or cooling. The heat or cooling from the thermal device 70 is transferred to the heat conductor 34 in the vehicle seat 12 to heat or cool the heat conductor 34 to predetermined temperature. The voltage-adjustment system 82 increases the voltage from the battery 80 for a predetermined time to minimize the amount of time required to heat or cool the heat conductor to the predetermined temperature.

After the predetermined time, at block 108, the adjustment cap 84 stops the operation of the voltage-adjustment system 82 so that the voltage-adjustment system 82 ceases increasing the voltage from the battery 80. For example, the adjustment cap 84 may be a timer programmed with a predetermined time limit that corresponds to a time the peak operating temperature is reached. At block 110, the battery 80 continues to supply voltage, e.g. 12 volts, to the heat-transfer station 52. As such, the heat-transfer station 52 continues to supply heating or cooling to the heat conductor 34 to maintain the temperature of the heat conductor 34 at the predetermined temperature.

In some embodiments, if the temperature of the heat conductor 34 is not maintained at the predetermined temperature, the voltage-adjustment system 82 may be reactivated supply additional voltage to bring the temperature of the heat conductor 34 back to the predetermined temperature. Once the predetermined temperature is reached, the adjustment cap 84 again stops the operation of the voltage-adjustment system 82 so that the battery 80 again maintains the predetermined temperature by supplying the battery voltage to the heat-transfer station 52.

In some embodiments, the occupant 40 may alter the desired temperature of the heat conductor 34. In such an embodiment, is additional heating or cooling is required, the voltage-adjustment system 82 may be reactivated to supply additional voltage to bring the temperature of the heat conductor 34 to the desired temperature. Once the newly selected temperature is achieved, the adjustment cap 84 stops the operation of the voltage-adjustment system 82 so that the battery 80 alone supplies voltage to the heat-transfer station 52 to maintain the temperature of the heat conductor 34.

Vehicle seats may be configured with heating and/or cooling elements to provide conditioning to the occupant of the seat, i.e a heating sensation or cooling sensation. Generally, these conditioning elements may be powered by a battery, for example, the vehicle battery. The vehicle battery is only capable of providing a predetermined voltage to the conditioning elements. Often, due to constraints in the voltage supply from the power source, the conditioning element requires a significant amount of time to reach a predetermined temperature. This results in inadequate conditioning to the occupant until the predetermined temperature is reached. A need remains to more quickly condition the seat of the occupant by managing the voltage supplied to the conditioning element.

1. An occupant support comprising
a vehicle seat including a cushion and trim arranged to extend around the cushion and
an occupant-comfort system including a heat-transfer station located in spaced-part relation from the trim and configured to move heat to the occupant in a heating mode and from the occupant in a cooling mode, a heat conductor coupled to the heat-transfer station and located between the cushion and the trim, the heat conductor configured to communicate heat between the heat-transfer station and the occupant, and a power supply coupled to the vehicle and configured to supply a voltage level to power a thermal device included in the heat-transfer station,
wherein the power supply includes a battery and a voltage adjustment system interconnecting the battery and the thermal device, the voltage adjustment system is configured to adjust the voltage level sent to the thermal device to minimize the amount of time required for the thermal device to reach a peak operating temperature.

2. The occupant support of claim 1, wherein the voltage adjustment system includes an adjustment cap including a timer programmed with a predetermined time limit corresponding to the peak operating temperature of the thermal device and configured to stop adjustment of the voltage sent to the thermal device once the predetermined time limit is reached.

3. The occupant support of claim 1, wherein the vehicle seat includes a seat back coupled to a seat bottom and the heat-transfer station is positioned in the seat back.

4. The occupant support of claim 1, wherein the vehicle seat includes a seat back coupled to a seat bottom and the heat-transfer station positioned in the seat bottom.

5. The occupant support of claim 1, wherein the vehicle seat includes a seat back coupled to a seat bottom, a first heat-transfer station included in occupant-comfort system is positioned in the seat back, and a second heat transfer station included in the occupant-comfort system is positioned in the seat bottom.

6. The occupant support of claim 1, further comprising a controller to select a heating or a cooling mode.

7. The occupant support of claim 1, wherein the thermal device comprises at least one of resistive wires, heat pipes, heat pumps, or an air conditioner.

8. The occupant support of claim 1, wherein the battery comprises a vehicle battery.

9. The occupant support of claim 1, wherein the voltage adjustment system supplies a voltage of about 16 volts to the thermal device for a predetermined time limit.

10. The occupant support of claim 9, wherein the battery supplies a voltage of about 12 volts after the predetermined time limit is reached.

11. A method of conditioning a vehicle seat, comprising
setting a predetermined temperature on a control panel;
adjusting a voltage sent to a thermal device to minimize an amount of time required for the thermal device to reach a peak operating temperature; and
stopping adjustment of the voltage sent to the thermal device once a predetermined time limit is reached.

12. The method of claim 11, further comprising supplying a voltage to the thermal device from the battery after the predetermined time limit is reached.
